(19) United States
(12) Patent Application Publication
(10) Pub. No.: US 2025/0376770 A1
(43) Pub. Date: Dec. 11, 2025

(54) NON-TRIAZOLE YELLOW METAL CORROSION INHIBITOR COMPOSITIONS AND METHODS OF TREATMENT

(71) Applicant: CHEMTREAT, INC., Glen Allen, VA (US)

(72) Inventors: Patrick WOOD, Midlothian, VA (US); Benjamin Edward Niemaseck, Chesterfield, VA (US); Alexsandra Corrigan, Richmond, VA (US); Douglas McIlwaine, Ashland, VA (US)

(73) Assignee: CHEMTREAT, INC., Glen Allen, VA (US)

(21) Appl. No.: 19/219,036

(22) Filed: May 27, 2025

Related U.S. Application Data
(60) Provisional application No. 63/656,837, filed on Jun. 6, 2024.

(51) Int. Cl. C23F 11/12; C02F 1/50; C02F 5/00

(52) U.S. Cl. CPC C23F 11/124; C02F 1/50; C02F 5/00; C02F 2303/04; C02F 2303/08; C02F 2303/20

(57) ABSTRACT

Methods and compositions for treating water to inhibit corrosion of yellow metal surfaces in water systems. The methods can include adding to the water a non-triazole corrosion inhibitor that is effective to inhibit corrosion of the yellow metal surface, and optionally a halogen stabilizer.

### CROSS-REFERENCE TO RELATED APPLICATIONS

This application claims the earlier filing date benefit of U.S. Provisional Application No. 63/656,837, filed on Jun. 6, 2024, the entirety of which is incorporated by reference herein.

### TECHNICAL FIELD

This disclosure relates generally to methods and compositions for inhibiting corrosion of yellow metals in water systems by using non-triazole chemistries, optionally together with a halogen stabilizer. In some aspects the non-triazole corrosion inhibitor can also advantageously act as a biodispersant to decrease biofilms in the water system.

### BACKGROUND

Corrosion of metal surfaces in water systems is a serious problem. Corrosion can cause undesirable consequences, including loss of heat transfer, increased cleaning frequency, equipment repairs and replacements, shutdowns, environmental problems and the increasing resources and costs associated with each. Some causes of increased corrosion of metal surfaces include high dissolved solids, acidic environments, elevated temperatures, microbiological growth, organic and mineral deposits, and fluids that contain relatively high concentration of gases such as oxygen, hydrogen sulfide, or carbon dioxide.

Copper and its alloys (all referred to generally as “yellow metals”) are also commonly used in cooling water treatment systems for heat exchanger tubing, pump impellers, and various other applications due to the natural corrosion resistance and high thermal conductivity of these metals. However, copper and its alloys are not immune to corrosion especially in the presence of halogen based oxidizing biocides such as hypochlorous acid (HOCl) or hypobromous acid (HOBr), which results in corrosion and possibly failure of equipment such as heat exchangers.

Conventional corrosion inhibitors for copper and its alloys include triazole-based compounds, i.e., a heterocyclic compound that includes a five-membered ring of two carbon atoms and three nitrogen atoms. Examples include tolyltriazole (TT), benzotriazole (BZT), chlorinated tolyltriazoles (Cl-TT), and brominated tolytriazoles (Br-TT). The triazoles work as yellow metal corrosion inhibitors by forming an inhibitor film on the surface of yellow metals through bonding with copper. However, the film formed by triazoles can be disrupted by halogen-based biocides (e.g., HOCl), which can lead to corrosion and equipment failure. The film formed by triazoles on the metal surface is also affected by high free chlorine and it requires additional triazole to re-passivate the film for corrosion protection. Additionally, in the bulk water, the triazole inhibitor can react with and be degraded by halogen-containing biocide and its corrosion inhibition capacity reduced. Triazole inhibitors and their halogenated derivatives also have high aquatic toxicity which can limit their application in industrial cooling water treatment, and the raw materials required to manufacture triazoles are often impacted by cost fluctuation and supply chain vulnerability.

Triazole inhibitors also have no biodispersant ability and thus, in water systems in which biofouling is an issue, a separate biodispersant must be added together with the triazole inhibitor.

### SUMMARY

In one aspect, this disclosure provides a method for treating water that contacts a yellow metal surface, where the method includes adding to the water (i) a non-triazole corrosion inhibitor that is effective to inhibit corrosion of the yellow metal surface, and (ii) a halogen stabilizer.

In another aspect, this disclosure provides a method for treating water that contacts a yellow metal surface, where the method includes adding to the water a non-triazole corrosion inhibitor that is effective to (a) inhibit corrosion of the yellow metal surface, and (b) reduce biofilming on the yellow metal surface.

In yet another aspect, this disclosure provides a method for treating water that contacts a yellow metal surface to inhibit corrosion of the yellow metal surface, where the method includes adding to the water an alkylamphocarboxylate surfactant.

### BRIEF DESCRIPTION OF THE DRAWINGS

FIGS. 1A-1D are graphs illustrating the corrosion rate of copper that is in contact with water treated with a non-triazole corrosion inhibitor and a halogen stabilizer; and

FIG. 2 is a graph illustrating the biodispersability properties of a non-triazole corrosion inhibitor and a halogen stabilizer.

### DETAILED DESCRIPTION OF EMBODIMENTS

The non-triazole corrosion inhibitor compositions described herein are effective to treat water to prevent or inhibit corrosion on yellow metals. In some aspects, the non-triazole corrosion inhibitor can simultaneously act as a biodispersant to disrupt biofilm formation and thereby reduce biofouling. In some aspects, the non-triazole corrosion inhibitor can be used together with a halogen stabilizer to improve performance of the corrosion inhibitor in the presence of halogens.

### Non-Triazole Corrosion Inhibitors

The non-triazole corrosion inhibitors are compounds that are not triazole compounds or derived from triazole compounds, and are effective to inhibit corrosion of yellow metals. Suitable non-triazole corrosion inhibitors for yellow metals include (1) imidazoles such as 2-imidazole and 2-benzimidazole and their derivatives; (2) biodegradable chelants such as methylglycine N,N-diacetic acid (MDGA) and glutamic acid diacetic acid (GLDA); (3) polyaspartic acid; (4) sugar acids such as glucoheptonate, gluconic acid, glucaric acid, citric/polycitric acid, ascorbic acid, crythorbic acid, glycolic acid, and adipic acid; (5) Good's buffers, such as N-(2-Acetamido)-2-aminoethanesulfonic acid, N-(2-acetamido)iminodiacetic acid, adenosine monophosphate, 2-amino-2-methylpropane-1,3-diol, 2-hydroxy-3-[(2-hydroxy-1,1-dimethylethyl)amino]-1-propanesulfonic acid, N,N-Bis(2-hydroxyethyl)-2-aminoethanesulfonic acid, Bicine, Bis-Tris, 1,3-bis(tris(hydroxymethyl)methylamino)propane, calcium alkyl benzene sulphonate, N-cyclohexyl-3-aminopropanesulfonic acid, N-cyclohexyl-2-hydroxyl-3-aminopropanesulfonic acid, 2-(cyclohexylamino)ethanesulfonic acid, 3-(Bis(2-hydroxyethyl)amino)-2-hydroxypropane-1-sulfonic acid, 3-[4-(2-Hydroxyethyl)-1-piperazinyl]propanesulfonic acid, 4-(2-Hydroxyethyl)-1-piperazinepropanesulfonic acid, 4-(4-(2-Hydroxyethyl)piperazin-1-yl)butane-1-sulfonic acid, 4-(2-hydroxyethyl)-1-piperazineethanesulfonic acid, 2-Hydroxy-3-(4-(2-hydroxyethyl)piperazin-1-yl)propane-1-sulfonic acid, 2-(N-morpholino)ethanesulfonic acid, 4-morpholinobutane-1-sulfonic acid, 3-(N-morpholino)propanesulfonic acid, 3-morpholino-2-hydroxypropanesulfonic acid, piperazine-N,N′ bis(2-ethanesulfonic acid), piperazine-1,4-bis(2-hydroxypropanesulfonic acid, 4-((1,3-dihydroxy-2-(hydroxymethyl)propan-2-yl)amino)butane-1-sulfonic acid, 3-((1,3-Dihydroxy-2-(hydroxymethyl)propan-2-yl)amino)propane-1-sulfonic acid, N-[tris(hydroxymethyl)methyl]-3-amino-2-hydroxypropanesulfonic acid, triethanolamine, N-tris(hydroxymethyl)methyl-2-aminoethanesulfonic acid, tricine, tris(hydroxymethyl)aminomethane, or a substituted compound or derivative of the foregoing; and (6) surfactants that inhibit corrosion on yellow metals, and derivatives and salts of any of the foregoing. Surfactants that may be suitable as yellow metal corrosion inhibitors can be anionic, cationic, or nonionic surfactants, and may include one or more of the following akylamphocarboxylates, linear alkylbenzene sulfonate, sodium lauryl sulfoacetate, disodium lauryl sulfosuccinate, sodium dioctyl sulfosuccinate, alkyl polyglycoside, sodium dodecylbenzene sulfonate, and combinations thereof.

The inventors discovered in connection with this disclosure that some surfactants are effective to prevent yellow metal corrosion and also act as a biodispersant to break up biofilms. In particular, surfactants having an amphoteric structure, surfactants having tertiary amine, surfactants having an amide, surfactants having a carboxylate group, and/or surfactants having an alkyl group with at least 7 carbon atoms may be useful. Alkylamphocarboxylates have been found to be particularly effective biodispersants and corrosion inhibitors on yellow metal. The alkylamphocarboxylates may have from 5 to 14 carbon atoms, or from 6 to 10 carbon atoms. Sodium cocoamphoacetate is shown in the examples below to be an effective corrosion inhibitor and an effective biodispersant.

The use of surfactants that have good biodispersancy properties with a halogen-containing biocide can dramatically improve the efficacy of the biocide programs because the surfactant can improve the performance of the biocide against biofilms in the water system, e.g., particularly in cooling water systems that are prone to biofilms. And the ability to treat water to prevent corrosion on yellow metals and to disrupt biofilms with a single component means that a separate biodispersant is not needed or can be used in substantially smaller amounts.

In some aspects, the non-triazole corrosion inhibitors may also prevent dezincification of yellow metal surfaces that are made from copper alloys that include zinc. Dezincification is a selective corrosion process for yellow metals that contain zinc (e.g., brass) in which zinc is selectively removed from the metallurgy leaving behind a porous predominantly copper alloy. Dezincification is an undesirable form of corrosion that can be prevented in some embodiments with the non-triazole corrosion inhibitors described herein.

### Halogen Stabilizer

Halogen-containing biocides are frequently used to treat water to kill microbes. For example, chlorine biocides can be added to water as bleach or molecular chlorine. Bromine compounds are also used as a biocide. Free halogen from these sources, in particular free chlorine (hypochlorous acid and hypochlorite) is a primary corrosive species in water systems that are in contact with yellow metals. It is believed that the free halogens can disrupt or break down films that are formed by many corrosion inhibitors on yellow metal surfaces thereby increasing the corrosivity of the water.

Thus, in some aspects, a halogen stabilizer can be added to the water in addition to the yellow metal corrosion inhibitors described above. The halogen stabilizer can react with the free halogen and convert a percentage of it to a less reactive, total halogen species, which may incidentally reduce the corrosivity of the water. It was unexpectedly discovered in connection with this disclosure that the halogen stabilizer can increase the efficacy of the corrosion inhibitor in the presence of free halogen in the water. The halogen stabilizer may include, but is not limited to, an unhalogenated hydantoin, cyanuric acid, or sulfamic acid.

Sulfamic acid and its organic compound derivatives, i.e., sulfonamides (e.g., toluenesulfonamide), are chemically distinct from ammonia or other organic amine-containing compounds used to produce haloamines but, like ammonia or many amines, typically contain a nitrogen-hydrogen bond which can react with and stabilize aqueous halogen species.

The hydantoin compound may be, for example, an unhalogenated alkyl hydantoin. An unhalogenated alkyl hydantoin is a heterocyclic organic compound the general structure of which is illustrated below.

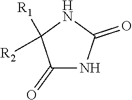

In the above structure, R1 and R2 are selected from H, CH3, C2H5, or C3H7. Preferably, R1 and R2 are both CH3. The unhalogenated alkyl hydantoin may be dimethyl hydantoin (DMH).

Hydantoin is a colorless solid that arises from the reaction of glycolic acid and urea. It is an oxidized derivative of imidazolidine. The inventors have found that an unhalogenated alkyl hydantoin compound is uniquely suited to “stabilize” halogen-containing biocides by the formation of biocidal byproducts such as N-chloro molecules through a reaction of hydantoin with bleach. These N-chloro molecules provide long-lasting protection and are more stable than pure chlorine products as they do not break down as quickly in water systems. It is known that in the absence of a halogen stabilizer compound, bleach, for example, rapidly and almost completely oxides into chloride. Thus, over time, the addition of halogen stabilizer like hydantoin may enable the use of lower amounts of halogen-containing biocide while still achieving the same efficacy.

### Treatment Method

The non-triazole yellow metal corrosion inhibitor, alone or with a halogen stabilizer, can be combined with water that contacts a metal surface to inhibit or prevent corrosion of the metal surface. The metal surface can include a copper metal or a copper alloy metal, and may be part of equipment or conduits in the water system. These methods of inhibiting corrosion can be used in aqueous systems including, but not limited to cooling water, cooling towers, water distribution systems, boilers, pasteurizers, water and brine carrying pipelines, storage tanks and the like. In general, water in these aqueous systems is at least 90 wt. % water, at least 95 wt. % water, or at least 99 wt. % water, for example.

The treatment can include adding the non-triazole yellow metal corrosion inhibitor to the water in amounts of from 0.1 ppm to 100 ppm, from 5 ppm to 50 ppm, or from 10 ppm to 25 ppm, for example. The halogen stabilizer can be added to the water in amounts of from 0.01 ppm to 100 ppm, 0.1 ppm to 20 ppm, or from 0.5 ppm to 10 ppm, for example. If both components are used, the yellow metal corrosion inhibitor can be combined with the halogen stabilizer and added to the water as a single composition, or the yellow metal corrosion inhibitor and the halogen stabilizer can be added to the water separately. A sufficient amount of the yellow metal corrosion inhibitor and the halogen stabilizer can be added to the water to maintain a corrosion rate of the yellow metal surfaces in the water system of less than 0.10 mils per year (mpy), or less than 0.05 mpy, such as from 0.005 mpy to 0.05 mpy. As indicated above, for yellow metal surfaces that are made from alloys that include zinc, the treatments described herein may also be added in sufficient amounts to prevent dezincification of the surface.

As indicated above, the water in the water system can also be treated with a halogen such as a halogen-containing biocide. The water can have at least 0.1 ppm of a halogen-containing biocide, at least 0.5 ppm, at least 1 ppm, or from 0.1 ppm to 50 ppm, or from 1 ppm to 20 ppm expressed as total halogen. Halogen-containing biocides may include, for example, hypochlorous acid or hypobromous acid.

The treatment methods described herein also contemplate determining the dosing of the halogen stabilizer based on the amount of the halogen-containing biocide. In this regard, the halogen stabilizer can be dosed in a molar ratio of 0.05 to 5 mols of halogen stabilizer per mol of halogen-containing biocide, from 0.2 to 1 mols of halogen stabilizer per mol of halogen-containing biocide, or from 0.3 to 0.8 mols of halogen stabilizer per mol of halogen containing biocide.

In some aspects, where the yellow metal corrosion inhibitor also has good biodispersancy properties, the water can be treated without adding a separate biodispersant (e.g., alkylpolyglucosides) or adding such separate biodispersants in small amounts (e.g., less than 0.5 ppm).

The corrosion inhibitor, and optionally the halogen stabilizer, can be dosed in response to a measured parameter of the water or of the metal surface, including when a measured amount of corrosion inhibitor drops below a predetermined threshold. The compounds can be added in response to a system demand of the system or surface demand of the metal surface.

System demand may be attributed to the presence of oxygen, halogens, other oxidizing species, microbial fouling, and other components in the aqueous system that can react with or remove, and thereby deactivate or consume, the inhibitor. System demand also includes inhibitor losses associated with bulk water loss through, for example, blowdown and/or other discharges from the treated system. System demand does not, however, include inhibitor that binds to or otherwise reacts with the wetted metal surfaces.

Surface demand is the consumption of the inhibitor attributed to the interaction between the inhibitor and a reactive metal surface. Surface demand will decline as the inhibitor forms a protective film or layer on those metal surfaces that were vulnerable to corrosion. Once all of the wetted surfaces have been adequately protected, the surface demand will be nothing or almost nothing. Once the surface demand is reduced to values close to zero, the inhibitor feed amount can be substantially reduced or even terminated for some period of time without compromising the effectiveness of the corrosion inhibition program.

### Examples

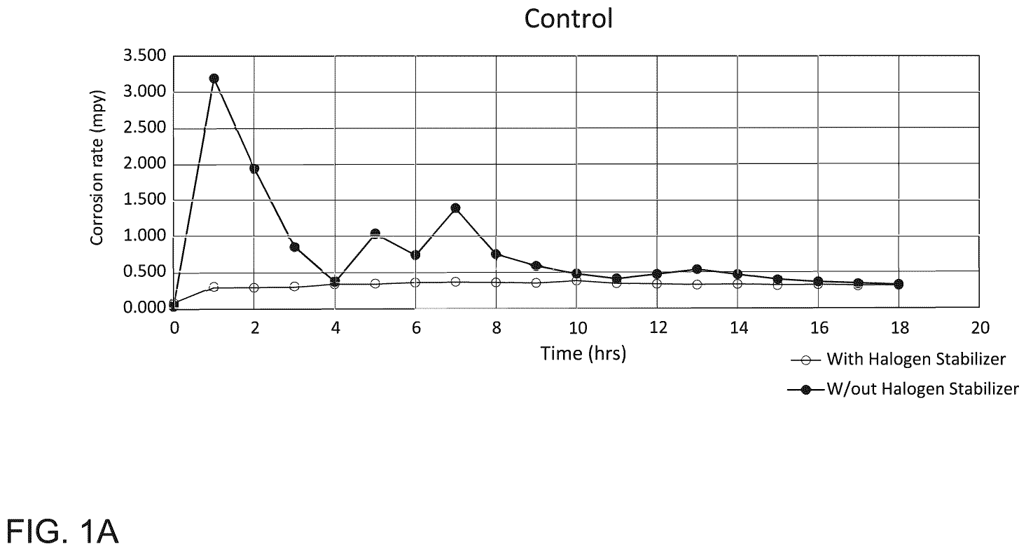

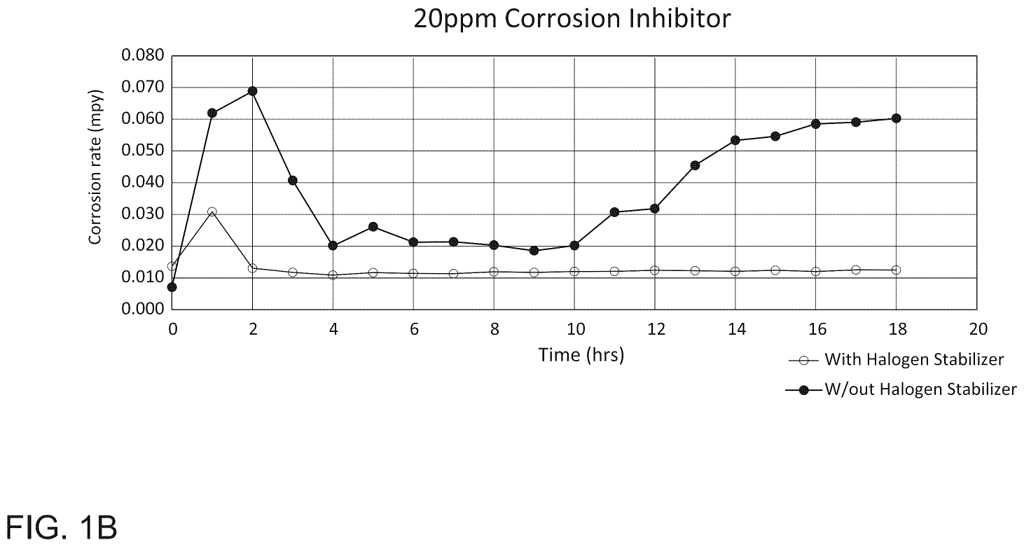

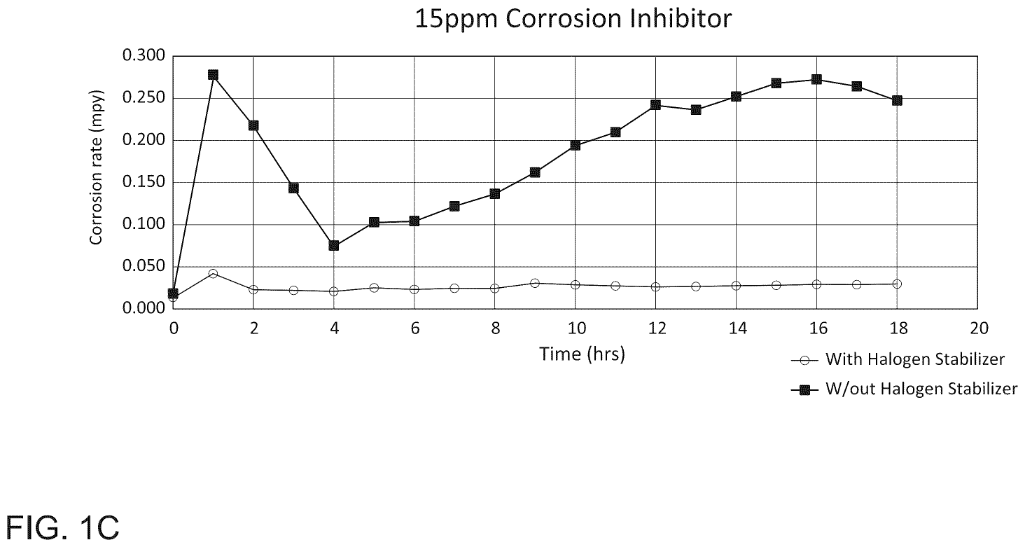

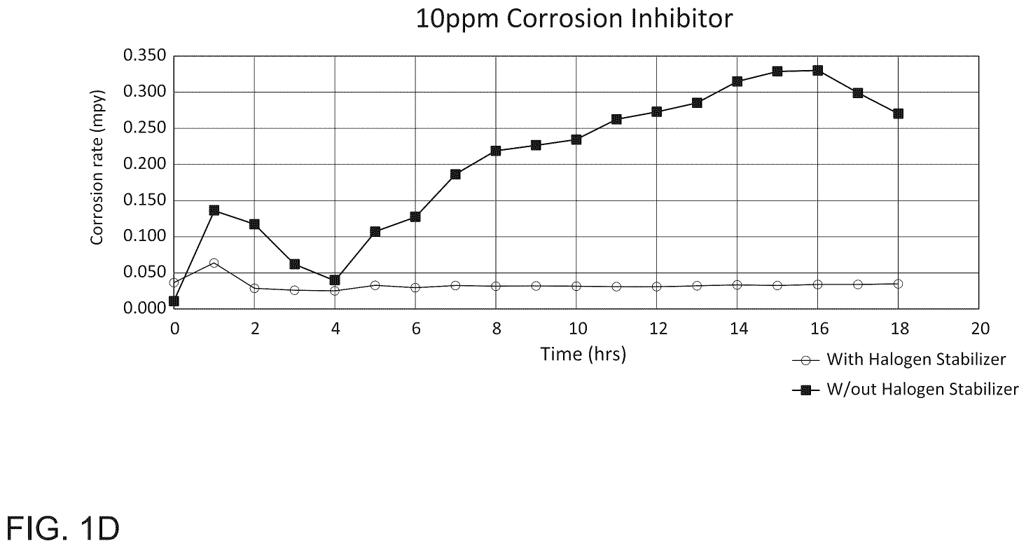

FIGS. 1A-1D are graphs showing the results of experiments in which the corrosion rate of copper is evaluated using different amounts of a cocoamphoacetate surfactant as a corrosion inhibitor. In the experiment, copper coupons (CD110) are placed in water having 1 ppm hypochlorite, and the corrosion rate is determined over time. FIG. 1A is a control in which no corrosion inhibitor is added. FIGS. 1B-1D dose the corrosion inhibitor at 20 ppm, 15 ppm, and 10 ppm, respectively. In each experiment, the corrosion rate is determined when no halogen stabilizer is added and when 0.98 ppm of hydantoin is added as a halogen stabilizer.

As can be seen, the cocoamphoacetate surfactant is effective at any of these doses in reducing corrosion rates as compared to the control. The addition of the halogen stabilizer substantially improves corrosion rates, and the combination of the cocoamphoacetate and the corrosion inhibitor can achieve sustained corrosion rates of less than 0.05 mpy.

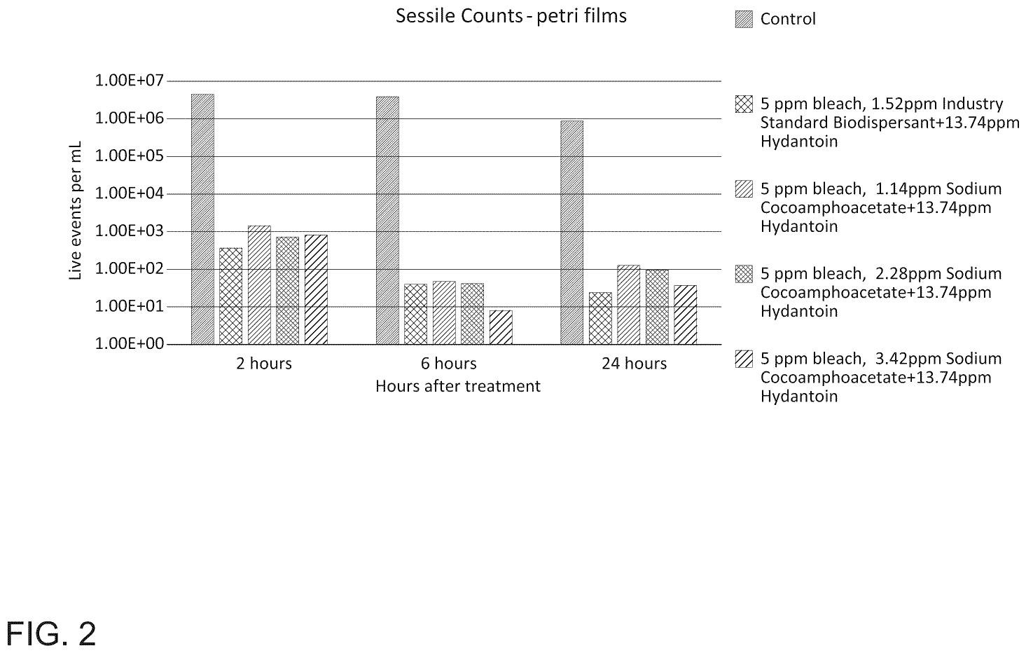

FIG. 2 is a graph showing the results of an experiment to measure the biodispersancy properties of alkylamphocarboxylate. In this experiment, the sessile bacteria counts were measured on petri films after treatment with either an industry standard biodispersant and hydantoin, or cocoamphoacetate and hydantoin. The control is untreated. It can be seen that cocoamphoacetate and hydantoin can achieve similar biodispersancy properties as the industry standard biodispersant over sustained periods when used in comparable amounts. This indicates that alkylamphocarboxylate surfactants have good biodispersancy properties and can be used as a corrosion inhibitor without the need to add other biodispersants to the water system.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes and omissions from the described embodiments may be made without departing from the spirit and scope of this disclosure, which is defined by the claims.

What is claimed is:

1. A method for treating water that contacts a yellow metal surface, the method comprising adding to the water (i) a non-triazole corrosion inhibitor that is effective to inhibit corrosion of the yellow metal surface; and (ii) a halogen stabilizer.

2. The method according to claim 1, wherein the non-triazole corrosion inhibitor is a surfactant.

3. The method according to claim 2, wherein the surfactant is an amphoteric surfactant.

4. The method according to claim 2, wherein the non-triazole corrosion inhibitor is an alkylamphocarboxylate surfactant.

5. The method according to claim 1, wherein the non-triazole corrosion inhibitor is an imidazole derivative.

6. The method according to claim 1, wherein the non-triazole corrosion inhibitor is a benzimidazole derivative.

7. The method according to claim 1, wherein the non-triazole corrosion inhibitor is a biodegradable chelant.

8. The method according to claim 1, wherein the non-triazole corrosion inhibitor is a polyaspartic acid.

9. The method according to claim 1, wherein the non-triazole corrosion inhibitor is a sugar acid.

10. The method according to claim 1, wherein the non-triazole corrosion inhibitor is a Good's buffer that is selected from the group consisting of N-(2-Acetamido)-2-aminoethanesulfonic acid, N-(2-acetamido)iminodiacetic acid, adenosine monophosphate, 2-amino-2-methylpropane-1,3-diol, 2-hydroxy-3-[(2-hydroxy-1,1-dimethylethyl)amino]-1-propanesulfonic acid, N,N-Bis(2-hydroxyethyl)-2-aminoethanesulfonic acid, Bicine, Bis-Tris, 1,3-bis(tris(hydroxymethyl)methylamino)propane, calcium alkyl benzene sulphonate, N-cyclohexyl-3-aminopropanesulfonic acid, N-cyclohexyl-2-hydroxyl-3-aminopropanesulfonic acid, 2-(cyclohexylamino)ethanesulfonic acid, 3-(Bis(2-hydroxyethyl)amino)-2-hydroxypropane-1-sulfonic acid, 3-[4-(2-Hydroxyethyl)-1-piperazinyl]propanesulfonic acid, 4-(2-Hydroxyethyl)-1-piperazinepropanesulfonic acid, 4-(4-(2-Hydroxyethyl)piperazin-1-yl)butane-1-sulfonic acid, 4-(2-hydroxyethyl)-1-piperazineethanesulfonic acid, 2-Hydroxy-3-(4-(2-hydroxyethyl)piperazin-1-yl)propane-1-sulfonic acid, 2-(N-morpholino)ethanesulfonic acid, 4-morpholinobutane-1-sulfonic acid, 3-(N-morpholino)propanesulfonic acid, 3-morpholino-2-hydroxypropanesulfonic acid, piperazine-N,N′ bis(2-ethanesulfonic acid), piperazine-1,4-bis(2-hydroxypropanesulfonic acid, 4-((1,3-dihydroxy-2-(hydroxymethyl)propan-2-yl)amino)butane-1-sulfonic acid, 3-((1,3-Dihydroxy-2-(hydroxymethyl)propan-2-yl)amino)propane-1-sulfonic acid, N-[tris(hydroxymethyl)methyl]-3-amino-2-hydroxypropanesulfonic acid, triethanolamine, N-tris(hydroxymethyl)methyl-2-aminoethanesulfonic acid, tricine, tris(hydroxymethyl)aminomethane, and a substituted compound of the foregoing.

11. The method according to claim 1, wherein the halogen stabilizer is selected from the group consisting of at least one of an unhalogenated hydantoin, cyanuric acid, and sulfamic acid.

12. The method according to claim 1, wherein the halogen stabilizer is an unhalogenated hydantoin.

13. The method according to claim 1, further comprising adding a halogenated biocide to the water in an amount of 0.1 to 50 ppm expressed as total halogen.

14. The method according to claim 1, wherein the non-triazole corrosion inhibitor is added to the water in an amount of 0.1 to 100 ppm.

15. The method according to claim 1, wherein the halogen stabilizer is added to the water in an amount of 0.01 ppm to 100 ppm.

16. The method according to claim 1, wherein the yellow metal surface is a copper alloy that includes zinc.

17. A method for treating water that contacts a metal surface, the method comprising adding to the water a non-triazole corrosion inhibitor that is effective to (a) inhibit corrosion of the metal surface, and (b) reduce biofouling on the metal surface.

18. The method of claim 17, wherein the metal surface includes a biofilm before the treatment, and the non-triazole corrosion inhibitor is added in sufficient amounts to disrupt the biofilm.

19. The method according to claim 17, further comprising adding a halogen stabilizer to the water.

20. The method of claim 17, wherein the non-triazole corrosion inhibitor is a cocoamphoacetate.

21. A method for treating water that contacts a yellow metal surface to inhibit corrosion of the yellow metal surface, the method comprising adding to the water an alkylamphocarboxylate surfactant.

22. The method according to claim 20, wherein the alkylamphocarboxylate surfactant has from 5 to 14 carbon atoms.

23. The method according to claim 20, wherein the alkylamphocarboxylate surfactant is added to the water in an amount of from 0.5 to 100 ppm.

24. The method according to claim 20, wherein the alkylamphocarboxylate surfactant is sodium cocoamphoacetate.

25. The method according to claim 20, further comprising adding a halogen stabilizer to the water.

26. A method for treating water that contacts a yellow metal surface, the method comprising adding to the water a non-triazole corrosion inhibitor and a halogen stabilizer in sufficient amounts to reduce the corrosion of the yellow metal surface to less than 0.1 mpy.
